(19) United States
(12) Patent Application Publication
(10) Pub. No.: US 2025/0270832 A1
(43) Pub. Date: Aug. 28, 2025

(54) Camper Pod

(71) Applicant: Tusca Outdoors, LLC, Lebanon, PA (US)

(72) Inventors: Joshua Perry Good, Lititz, PA (US); Adam Janney, Lebanon, PA (US)

(73) Assignee: Tusca Outdoor, LLC, Lebanon, PA (US)

(21) Appl. No.: 19/059,438

(22) Filed: Feb. 21, 2025

Related U.S. Application Data
(60) Provisional application No. 63/557,118, filed on Feb. 23, 2024.

(51) Int. Cl. E04H 1/12; E04H 15/06

(52) U.S. Cl. CPC E04H 1/12; E04H 15/06

(57) ABSTRACT

A camper pod includes a camper housing and an attachment portion. The camper housing has a housing body. The camper housing also has a pair of structure layers positioned on opposite surfaces of the housing body. The housing body is formed of a foam material. The pair of structure layers are each formed of a resin material deposited on the foam material. The attachment portion removably attaches the camper housing to a transportation element.

### CROSS-REFERENCE TO RELATED APPLICATION

This application claims the benefit of the filing date under 35 U.S.C. § 119 (e) of U.S. Provisional Patent Application No. 63/557,118, filed on Feb. 23, 2024.

### FIELD OF THE INVENTION

The present invention relates to a camper pod and, more particularly, to an insulated and lightweight camper pod removably attachable to a transportation element.

### BACKGROUND

Campers that are mountable in truck beds or otherwise attachable to vehicles are typically heavy and cumbersome, even for small campers, making them difficult for users to manipulate and attach. These campers, due to the material and construction of the camper, are also very expensive. The combination of weight and expense makes many campers unusable or inaccessible to users who desire an insulated and transportable camping structure.

### SUMMARY

A camper pod includes a camper housing and an attachment portion. The camper housing has a housing body and a pair of structure layers positioned on opposite surfaces of the housing body. The housing body is formed of a foam material. The pair of structure layers are each formed of a resin material deposited on the foam material. The attachment portion removably attaches the camper housing to a transportation element.

### BRIEF DESCRIPTION OF THE DRAWINGS

The invention will now be described by way of example with reference to the accompanying figures, of which:

FIG. 1 is a perspective view of a camper pod according to an exemplary embodiment;

FIG. 2 is a perspective view of a camper pod according to another exemplary embodiment;

FIG. 3 is a rear schematic view of the camper pod of FIG. 1 removably attached to a transportation element and having a shield;

FIG. 4 is a front perspective view of the camper pod of FIG. 1 with an attachment position removably attaching the camper pod to the transportation element;

FIG. 5A is a perspective sectional view of a portion of the camper pod of FIG. 1 and a portion of the transportation element of FIGS. 3 and 4 taken along line B-B′ of FIG. 3;

FIG. 5B is another perspective sectional view of the portion of the camper pod of FIG. 5A and the portion of the transportation element of FIG. 5A taken along line B-B′ of FIG. 3;

FIG. 6 is a schematic sectional view of a material of the camper pod of FIG. 1 taken along line A-A′ of FIG. 1;

FIG. 7 is a rear perspective view of the camper pod of FIG. 2 having an attachment portion removably attaching the camper pod to another transportation element;

FIG. 8 is a rear perspective view of the camper pod of FIG. 1 having another attachment portion removably attaching the camper pod to the transportation element;

FIG. 9 is an enlarged perspective view of portion C of FIG. 8;

FIG. 10A is a perspective view of one accessory element of a plurality of accessory elements attached to the camper pod of FIG. 1 or the camper pod of FIG. 2;

FIG. 10B is a perspective view of two different accessory elements of the plurality of accessory elements attached to the camper pod of FIG. 1 or the camper pod of FIG. 2;

FIG. 10C is a perspective view of another accessory element of the plurality of accessory elements attached to the camper pod of FIG. 1 or the camper pod of FIG. 2;

FIG. 10D is a plan view of an attachment assembly attachable to the camper pod of FIG. 1 or the camper pod of FIG. 2; and

FIG. 11 is a flowchart of a method of assembling a camper pod according to an exemplary embodiment.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein; rather, these embodiments are provided so that the present disclosure will convey the concept of the invention to those skilled in the art. Moreover, the embodiments and features thereof are only possible configurations in which, however, the individual features as described herein can be provided independently of one another or can be omitted.

Throughout the specification, various terms are used to describe a camper pod 1. The term “removably attachable”, or any iteration thereto, is intended to mean that an element is attachable to another element such that a secure connection between the elements is made, but the connection can easily be undone without damaging either of the elements.

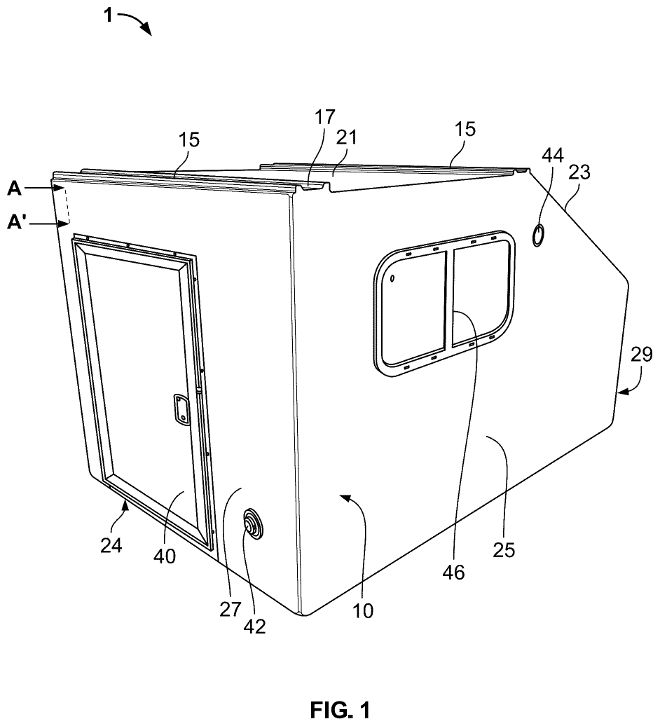

A relative thickness, length, or width of the elements described in more detail below appear in FIGS. 1-10D. The relative thickness, length, or width of the elements are merely illustrative and are not meant to be representative of a particular thickness, length, or width of any of the elements.

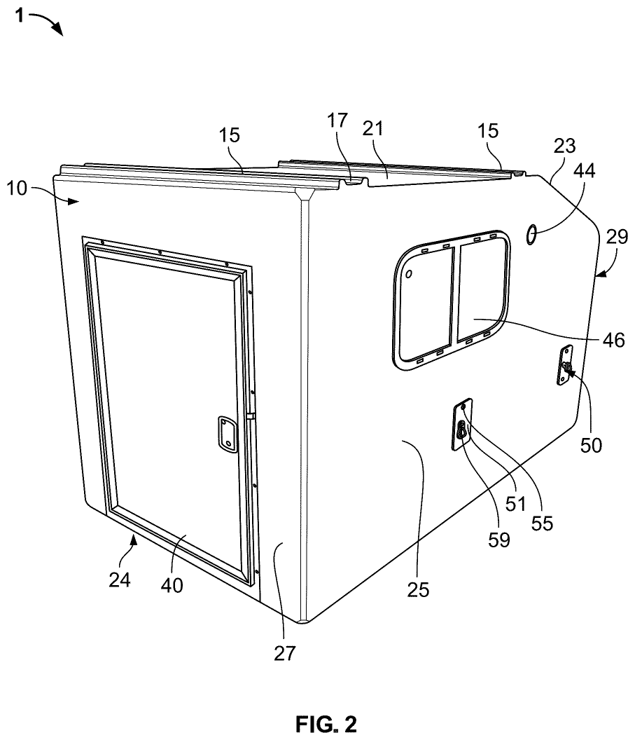

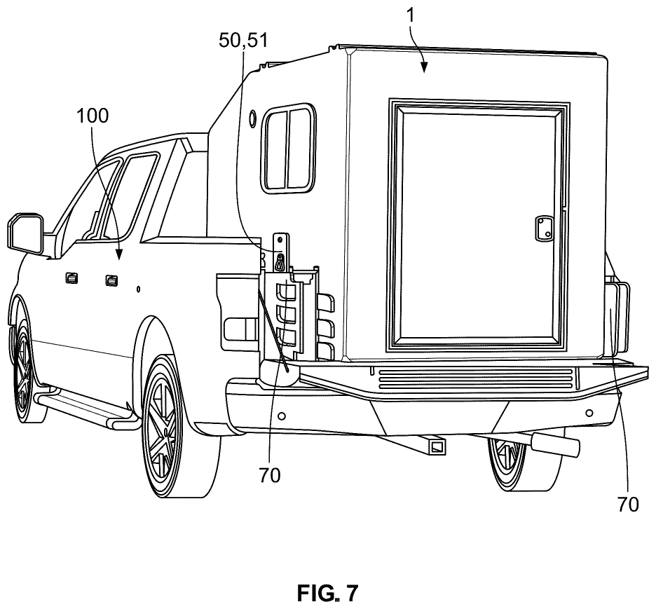

A camper pod 1 according to an exemplary embodiment is shown in FIGS. 1, 3, and 4, and 8, and an alternative exemplary embodiment of the camper pod 1 is shown in FIGS. 2 and 7. The camper pod 1, as described below, will primarily be described with reference to the camper pod 1 according to FIGS. 1, 3, 4, and 8. Only differences between the configuration of the camper pod 1 according to FIGS. 2 and 7 and the camper pod 1 according to FIGS. 1, 3, 4, and 8 will be described in detail when referencing the alternative embodiment; a primary difference between the camper pod 1 according to FIGS. 1, 3, 4, and 8 and the camper pod 1 according to FIGS. 2 and 7 are differences in dimensions, particularly lateral dimensions.

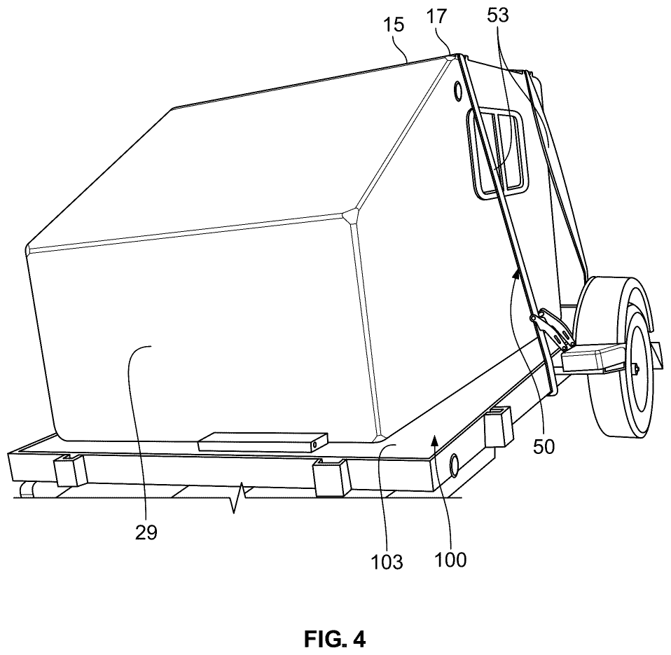

The camper pod 1 comprises a camper housing 10, as shown in FIG. 1, and an attachment portion 50 disposed on the camper housing 10, as shown in FIGS. 4, 5A-5B, and 7-9. The attachment portion 50 is used to removably attach the camper housing 10 to a transportation element 100, as described in detail below.

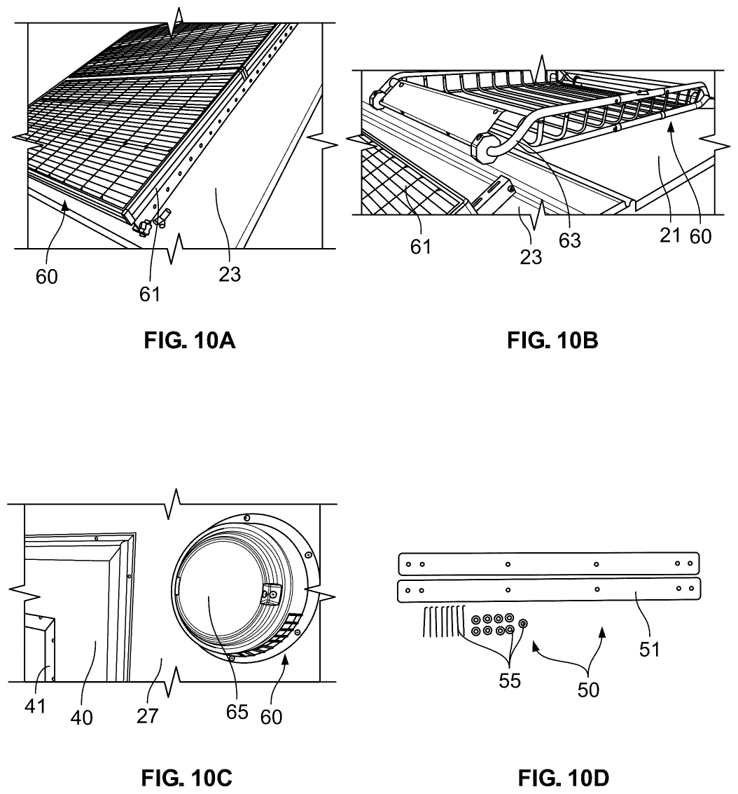

The camper housing 10, as shown in FIGS. 1 and 10B, has a first roof 21 and a second roof 23 adjacent to the first roof 21 and extending from the first roof 21. The camper housing 10, as shown in FIG. 1, also has a bottom 24 opposite the first roof 21 and parallel to the first roof 21.

As shown in the embodiment of FIG. 1, the first roof 21 has an approximately flat shape and the second roof 23 has an angled shape. The second roof 23 may extend at an angle greater than 0° and less than 90° with respect to a plane of the first roof 21. In the shown embodiment, the second roof 23 extends at an angle of approximately 30° with respect to the plane of the first roof 21. In other embodiments, as shown in FIG. 2, the second roof 23 may have a less angled shape, extending at a shallower angle with respect to the plane of the first roof 21. In other embodiments, the second roof 23 may extend at any angle from the first roof 21 that is suitable for reducing wind drag on the camper pod 1. In further embodiments, the camper housing 10 only has the flat first roof 21 or the angled second roof 23.

As shown in FIG. 1, the camper housing 10 also has a pair of sidewalls 25 opposite each other, a rear wall 27, and a front wall 29 opposite the rear wall 27. The sidewalls 25, the rear wall 27, and the front wall 29 connect the bottom 24 and the roofs 21, 23. The camper housing 10, including the bottom 24, the roofs 21, 23, and the walls 25, 27, 29, defines an interior to provide a shelter for a user.

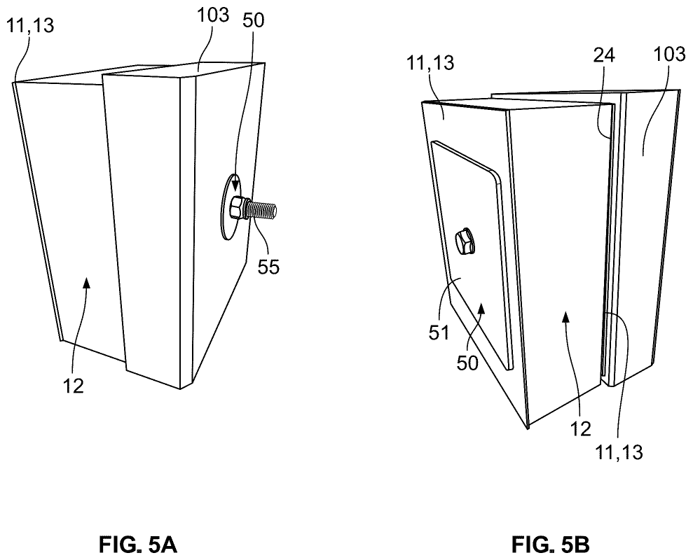

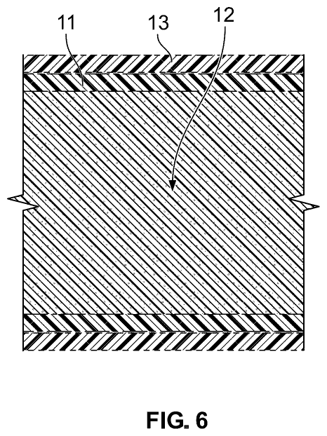

The parts of the camper housing 10, including the bottom 24, the roofs 21, 23, and the walls 25, 27, 29, are all formed of a same plurality of layers of material 11, 12, 13. The layers of the parts of the camper housing 10, as shown in FIGS. 5A, 5B, and 6, include a pair of structure layers 11 on opposite sides of a housing body 12, and a UV protection layer 13 on at least one of the structure layers 11.

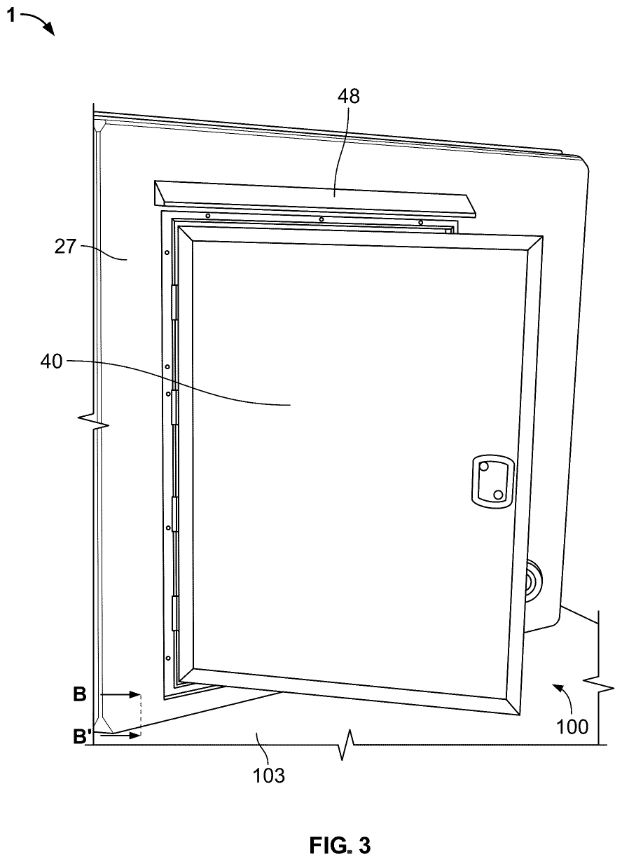

FIGS. 5A and 5B show perspective sectional views of a portion of the camper pod 1 taken along line B-B′ of FIG. 3. The portion of the camper pod 1 shown in FIGS. 5A and 5B is shown separated from the rest of the camper pod 1 only for clarity in illustrating the layers 11, 12, 13 of material of the camper housing 10 and one possible form of attachment between the camper pod 1 and a substrate 103 of a transportation element 100; the portion of the camper pod 1 shown in FIGS. 5A and 5B is not separate from the camper pod 1 during use. FIG. 6 shows a schematic sectional view of the camper pod 1 taken along line A-A′ of FIG. 1, also showing the layers of material 11, 12, 13 of each part of the camper housing 10.

The housing body 12, shown in FIGS. 5A, 5B, and 6, is formed of a foam material. In an embodiment, the foam material is a high-density EPS foam with a density of 2.4lbs/ft³. In another embodiment, the foam material may be an EPS foam with a density greater or less than 2.4lbs/ft³. In various other embodiments, the foam material may be any type of closed-cell foam that allows the housing body 20 to function as described herein. In another embodiment, the foam material is a composite foam material formed of a foam adhered with an aluminum layer. The aluminum layer may be a thin gauge aluminum layer.

The pair of structure layers 11, shown in FIGS. 5A, 5B, and 6, are disposed on opposite sides of the housing body 12. The structure layers 11, as described below, are coated on the sides of the housing body 12 in a manner that is not removable from the housing body 12. The structure layers 11 are each formed of a resin material. In an embodiment, the resin material is a pure aromatic polyurea, such as a 100% pure aromatic polyurea. In various other embodiments, the resin material may be a hybrid polyurea, such as a polyurea mixed with a polyurethane, an aliphatic polyurea, or any other material that allows the structure layers 11 to function as described herein.

As shown in FIGS. 5A, 5B, and 6, the UV protection layer 13 is disposed on a side of at least one of the structure layers 11 opposite the housing body 12. In an embodiment, the UV protection layer 13 is disposed on both structure layers 11 on the side opposite the housing body 12. The UV protection layer 13, in an embodiment, is a layer of UV paint that is adhered to the structure layer 11. In another embodiment, the UV protection layer 13 may be a UV protective material that is integrated into the resin material of the structure layers 11.

In the embodiment shown in FIGS. 1 and 4, the camper housing 10 also comprises an embedded strip 15. The embedded strip 15 is positioned on the first roof 21 and extends between the side walls 25. In an embodiment, the embedded strip 15 has a pair of protrusions that extend from the first roof 21 and form a groove 17 between them. In the shown embodiment, the camper housing 10 has a pair of embedded strips 15 that are attached to the first roof 21, parallel to one another, and spaced apart from one another, with one positioned adjacent to the rear wall 17 and one positioned adjacent to the second roof 23. In an embodiment, the embedded strip 15 is made of a composite wood material. In various other embodiments, the embedded strip 15 may be made of any other structurally stable material.

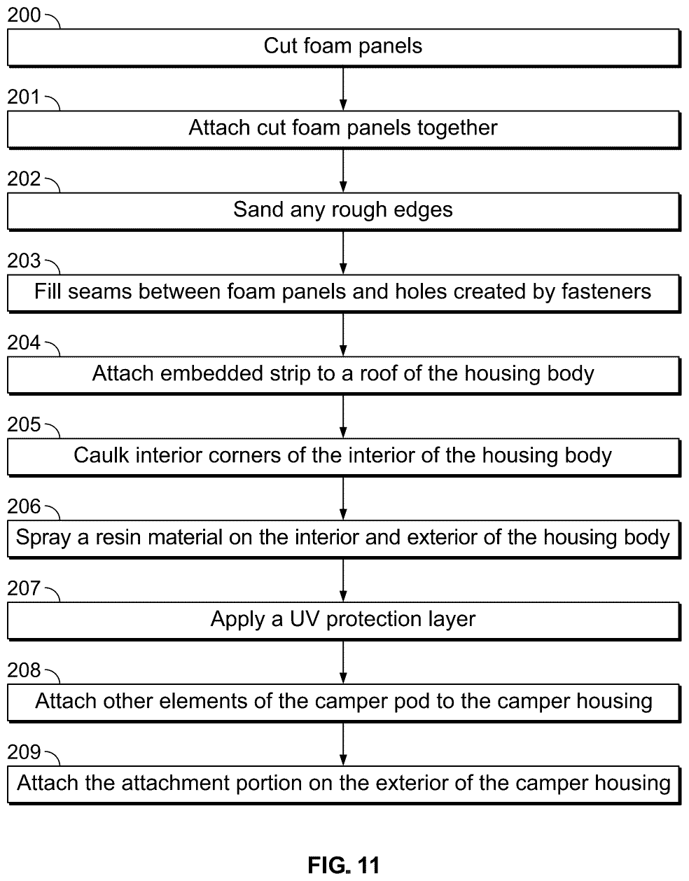

A method of assembling the camper pod 1 shown in FIGS. 1, 3, 4, and 8, and the alternative embodiment of the camper pod 1 shown in FIGS. 2 and 7, is now described primarily with reference to FIG. 11.

The different embodiments of the camper pod 1, particularly shown in FIGS. 1 and 2, are similarly assembled. The camper pods 1 according to the various embodiments, however, have different lengths and/or widths (e.g., different sized panels of the foam material that form the housing body 12). While assembly of the camper pod 1 is described in a specific order herein, the sequence of the steps are merely exemplary; the sequence of the steps may be changed, additional steps may be added, and/or steps may be completed simultaneously. Attachments to the housing body 12 may also be interchangeably described as attachments to, or elements of, the camper housing 10; thus, as described herein, when an element is described as being attached to the camper housing 10, the element is also attached to the housing body 12, the UV protection layer 13 and/or the pair of structure layers 11.

A plurality of foam panels made of the foam material of the housing body 12 are cut in various sizes and shapes in a first step 200. The foam panels are cut to form various parts 21, 23, 24, 25, 27, 29 of the camper pod 1 and overall sizes of the camper pod 1. Two exemplary embodiments of the camper pod 1 shown in FIG. 1 may have the following dimensions and weights once assembled: (1) outside dimensions: 79″ L×58″ W×54″ H; interior dimensions: 74.5″ L×54″ W×48″ H; weight: 180 lbs; and (2) outside dimensions: 89″ L×58″ W×54″ H; interior dimensions: 84.5″ L×54″ W×48″ H; weight: 190 lbs. An exemplary embodiment of the camper pod 1 shown in FIG. 2 may have the following dimensions and weight once assembled: outside dimensions: 89″ L×48″ W×54″ H; interior dimensions: 84.5″ L×44″ W×48″ H; weight: 188 lbs or 180-190 lbs. In other embodiments, the camper pod 1 may have other exterior dimensions and other interior dimensions in order to adapt the size of the camper pod 1 to various transportation elements 100. The camper pod 1 may also be lighter or heavier than in the shown embodiments, for example any weight less than 200 lbs., but in all embodiments is sufficiently light to be manually liftable by a group of people.

In an embodiment, each of the foam panels of the housing body 12 has a thickness of at least 2″. In an embodiment, the thickness of the housing body 12 is different at different parts of the camper housing 10; in an exemplary embodiment, the thickness of the foam panel is 2.5″ on the first roof 21, the second roof 23, and the bottom 24, and the thickness of the foam panel is 2″ on the pair of sidewalls 25, the rear wall 27, and the front wall 29. In various other embodiments, the thickness of the foam panels of the housing body 12 that form the parts 21, 23, 24, 25, 27, 29 of the camper housing 10 may be the same or different on the various parts 21, 23, 24, 25, 27, 29 of the camper housing 10 and may be greater or smaller than the thicknesses described herein.

The cut foam panels of the housing body 12 are then attached together in a second step 201, shown in FIG. 11. In an embodiment, the panels of the housing body 12 are attached using an adhesive, such as an industrial hot glue, and fasteners, such as screws. First, the adhesive is applied to the cut foam panels. The foam panels are then assembled to form the structure of the camper housing 10 having a shape as shown in FIG. 1 or 2. Second, before the adhesive cures, the fasteners are screwed into the foam panels to secure the foam panels in position.

Any rough edges of the assembled panels of the housing body 12 are then sanded flat in a third step 202. A joint compound is used to cover any seams between adjacent cut foam panels, or holes created by the fasteners, in a fourth step 203. Another sanding step of sanding the joint compound may occur after the joint compound dries for between 6-8 hours.

The embedded strip 15, or a plurality of embedded strips 15, as shown in FIGS. 1-2, are then attached to the first roof 21 in a fifth step 204. In an alternative embodiment, the embedded strip(s) 15 can be attached anywhere on the assembled housing body 12 panels, or alternatively, may be omitted. In various embodiments, the embedded strip(s) 15 are attached to the first roof 21 with an adhesive, a fastener, or in any way that secures the embedded strip(s) 15 in the position described herein.

Interior corners of an interior of the assembled housing body 12 are then caulked in a sixth step 205. In an embodiment, all interior corners are caulked and then the caulk is allowed to dry.

The resin material is then deposited on the foam panels of the housing body 12 to form the pair of structure layers 11 in a seventh step 206 shown in FIG. 11. During the seventh step 206, a proportioner is used to spray the resin material on the interior and the exterior of the housing body 12 on opposite surfaces of the housing body 12 to form an interior structure layer 11 and an exterior structure layer 11. The proportioner is also used to spray the resin material on the embedded strip 15. In an alternative embodiment, the embedded strip 15 is not attached on the first roof 21 of the housing body 20 until after the seventh step 206.

In the seventh step 206, the proportioner sprays the resin material as follows: (1) the resin material and an isocyanate (ISO) are separately heated, (2) the heated resin material and the heated ISO are pumped through individual hoses to a tip of a spray gun of the proportioner, (3) the heated resin material and the heated ISO are combined at the tip of the spray gun, and (4) the combined heated resin and the heated ISO are sprayed onto the foam material of the housing body 12 and the embedded strip(s) 15 at a high pressure, such as a pressure of approximately 3200 psi, and a high temperature, such as a temperature greater than 150 degrees Fahrenheit. In an embodiment, the proportioner is a two-part proportioner. In various other embodiments, the aforementioned pressure and temperature may be any pressure and temperature that adheres the resin material combined with the ISO on the housing body 12 to form the structure layers 11 on the housing body 12. In an exemplary embodiment, a thickness of the structure layers 11 deposited on the housing body 12 is greater than or equal to 2/32″ and less than or equal to 5/32″.

The UV protection layer 13 is then applied onto the structure layers 11, such as by painting, in an eighth step 207. In an embodiment, the UV protection layer 13 is UV protective paint that is painted onto an outer surface of the exterior structure layer 11 or both of the structure layers 11. The eighth step 207 may be omitted if the resin material used in the seventh step 206 is the aliphatic polyurea or another type of resin material that includes UV protection material; in this embodiment, the UV protection layer 13 and the structure layers 11 are the same layers.

The camper housing 10 of the camper pod 1 is assembled at the end of step 207.

Other elements of the camper pod 1, such as a door 40, a port 42, a vent 44, a pair of windows 46, an angled shield 48, and a plurality of accessory elements 60, may then be attached to the camper housing 10, as shown in FIGS. 1, 3, and 10A-10C, in a ninth step 208 shown in FIG. 11. The aforementioned other elements of the camper pod 1 may also be omitted or placed on any part of the camper housing 10 (e.g., the port 42 is on the rear wall 27 in the embodiment shown in FIG. 1, but not on the rear wall 27 on the embodiment shown in FIG. 2), or additional other elements may be attached to the camper housing 10.

As shown in FIGS. 1-3, the door 40 is attached to an opening in the rear wall 27. The opening in the rear wall 27 is sized to fit the door 40 and is either formed during the first step 200 or after the second step 201 by cutting the foam panels of the housing body 12. The door 40 is a fiberglass camper style door. In an embodiment, the door 40 may have a door window 41, as shown in FIG. 10C. In various other embodiments, the door 40 may be any type of door that provides access to an interior of the camper pod 1.

As shown in FIG. 3, the angled shield 48 may be attached to the rear wall 27 above a top of the door 40. In various embodiments, the angled shield 48 may be attached to the rear wall 27 with an adhesive, a fastener, or in any way that provides environmental protection for the seams of the door 40.

As shown in FIG. 1, the port 42 is attached to an opening in the rear wall 27. The opening in the rear wall 27 is sized to fit the port 42 and is either formed during the first step 200 or after the second step 201 by cutting the foam panels of the housing body 12. In an exemplary embodiment, the port 42 is a 3″ electrical port. In various other embodiments, the port 42 may be any type of outlet that allows the camper pod 1 to function as described herein. In various other embodiments, the camper pod 1 may have any number of outlets 42.

As shown in FIGS. 1-2, the vent 44 is attached to an opening in the sidewall 25. The opening in the sidewall 25 is sized to fit the vent 44 and is either formed during the first step 200 or after the second step 201 by cutting the foam panels of the housing body 12. In an exemplary embodiment, the vent 44 is a 3″ vent. In various other embodiments, the vent 44 may be any type of vent that allows the camper pod 1 to function as described herein. In another embodiment, both sidewalls 25 have the vent 44. In yet another embodiment, the vent 44 is a 12V powered fan vent on the sidewall(s) 25, and/or a 12V powered fan on the first roof 21 and/or the second roof 23.

As shown in FIGS. 1-2 and 7-8, the pair of windows 46 are each attached to an opening in one sidewall 25. The opening in each sidewall 25 is sized to fit each window 46 and each opening is either formed during the first step 200 or after the second step 201 by cutting the foam panels of the housing 12. In an exemplary embodiment, each window 46 is a standard RV window that slides and has a screen. In various other embodiments, the windows 46 may be any type of window used in campers or RVs. In another embodiment, only one window 46 is attached to one sidewall 25. In various other embodiments, the camper pod 1 may have any number of windows 46.

After the door 40, the port 42, the vent 44, and the windows 46 are attached to the housing body 12 in the step 208, silicone is applied around the door 40, port 42, vent 44, and windows 46.

As shown in FIGS. 10A-10C, the plurality of accessory elements 60 attached to the camper housing 10 in the step 208 can include a solar panel 61 attached on the second roof 23, a storage rack 63 attached on the first roof 21, and a fan 65 attached on the rear wall 27. In various embodiments, the solar panel 61 is attached to the second roof 23 with an adhesive, a fastener, or in any way that allows the solar panel 61 to function as described herein. In various embodiments, the storage rack 63 is attached to the first roof 21 with an adhesive, a fastener, or in any way that allows the storage rack 63 to function as described herein. The fan 65 is attached to the camper housing 10 in the same way as the vent(s) 44. The fan 65 may be installed on the rear wall 27, as shown in FIG. 10C, or in lieu of any of the vent(s) 44.

The plurality of accessory elements 60 may also include various fixtures. For example, the plurality of accessory elements 60 may include a carpet, air conditioning, heaters, heat pumps, handles, hooks, etc. The carpet, for example, may be attached to the bottom 24 on the interior of the housing body 20 with, for example, an adhesive.

The attachment portion 50 is then attached to the camper housing 10 in a tenth step 209 shown in FIG. 11. Various configurations of the attachment portion 50 are described below; however, these configurations are merely exemplary. In various other embodiments, the attachment portion 50 may include any element, and may be attached anywhere on the camper housing 10, that allows the attachment portion 50 to attach the camper housing 10 to the transportation element 100. Different embodiments of the attachment portion 50 are shown in FIGS. 4, 5A-5B, and 7-9. Various configurations of the attachment portion 50 are now described.

As shown in FIG. 4, a first configuration of the attachment portion 50 includes a strap 53. As shown in FIG. 4, the strap 53 is received by the groove 17 of the embedded strip 15 and is fed along the groove 17 and around the sidewalls 25. In an embodiment, the strap 53 is a ratchet strap. In various other embodiments, the strap 53 may be any type of strap that allows the strap 53 to function as described herein.

As shown in FIGS. 5A-5B, a second configuration of the attachment portion 50 includes a plurality of plates 51 and a plurality of fasteners 55. A hole or plurality of holes are drilled in the bottom 24 on the exterior of the housing body 20 for each plate 51. Each plate 51 is then secured to the bottom 24 with the fasteners 55. In an embodiment, as shown in FIG. 5B, each plate 51 has an approximately square shape and the plurality of plates 51 comprises more than two of the plates 51. In another embodiment, the plurality of plates 51 only includes two of the plates 51. The two plates 51 of another embodiment of the attachment portion 50, as shown in FIG. 10D, each have an approximately rectangular shape.

In an embodiment, the fasteners 55 may include washers, bolts, and locking nuts. In an exemplary embodiment, the washers may be 4″×4″ 14-gauge steel washers and 5/16 washers, the bolts may be 5/16-18×4.5″ stainless steel bolts, and the locking nuts may be 5/16-18 nylon locking nuts. In various other embodiments, the fasteners 55 may be any type of fastener that allows the attachment portion 50 to attach the camper housing 10 to the transportation element 100.

As shown in FIGS. 7-9, a third configuration of the attachment portion 50 includes a plurality of plates 51, the fasteners 55, and a tie down ring 59. Holes are first drilled into the camper housing 10. For example, holes are drilled into the sidewall 25, or the pair of sidewalls 25, for each plate 51. Each plate 51 is then secured to the sidewall 25 with the fasteners 55. The tie down ring 59 is then secured to the plate 51 and the sidewall 25 with the fasteners 55. In an embodiment, the tie down 57 is a turnbuckle tie down. In another embodiment, the tie down ring 59 is a D-ring.

A transportation element 100 is now described with reference to FIGS. 3-5B and 7-9. The transportation element 100 may be any type of transportation device, such as a truck with a truck bed or a trailer, that can have the camper pod 1 removably attached to it. The transportation element 100 may have a substrate 103, such as a floor or floorboards, as shown in FIGS. 3-5B. The transportation element 100 may also have an anchor 101. In an embodiment, the anchor 101 is a D-buckle anchor.

Removable attachment of the camper pod 1 to the transportation element 100 with the various configurations of the attachment portion 50 is now described with reference to FIGS. 3-5B and 7-9. A camper according to an embodiment of the invention includes the camper pod 1 and the transportation element 100.

As shown in FIG. 4, the first configuration of the attachment portion 50 is removably attached to the transportation element 100 with the strap 53. The strap 53, or a plurality of straps 53, are attached to the camper pod 1 as described above and then a portion of the strap 53 is fed under the transportation element 100, as shown in FIG. 4. The camper pod 1 is then removably attached to the transportation element 100 when each strap 53 or the strap 53 is tightened and secured, for example by a ratchet. In various other embodiments, the strap 53 may be fed on/under any part of the transportation element 100 that allows the camper pod 1 to be removably attached to the transportation element 100 with the strap 53.

As shown in FIGS. 3 and 5A-5B, the second configuration of the attachment portion 50 is removably attached to the transportation element 100 with the plurality of plates 51, and the fasteners 55. A hole for each plate 51 is drilled in the bottom 24 as described above and then a plurality of complementary holes, each lining up with each hole in the bottom 24, are drilled in the substrate 103, such as a bed of a trailer. Each plate 51 is then placed on the exterior structure layer 11 and/or the interior structure layer 11 in alignment with the holes. The fasteners 55 are then placed through the holes to attach the camper pod 1, via the bottom 24, to the transportation element 100. In another embodiment, the plates 51 may be omitted. In various other embodiments, the holes drilled into the bottom 24 and the substrate 103 may be threaded and the fasteners 55 may only include a bolt and washer instead of a bolt, washer, and nut.

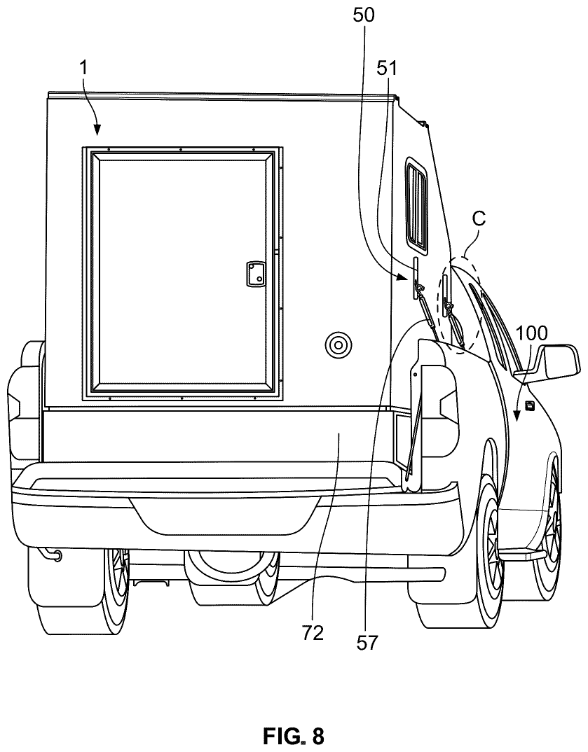

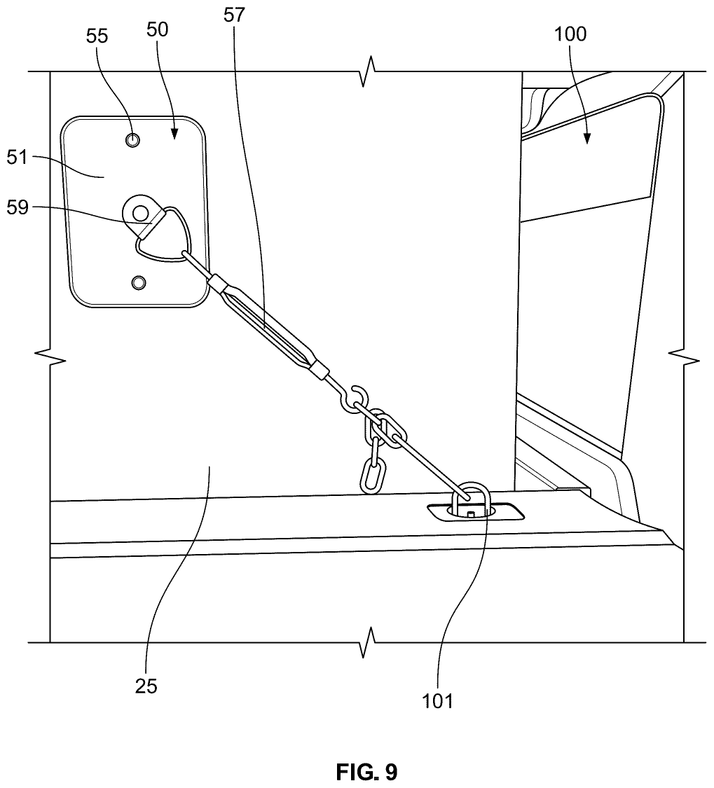

As shown in FIGS. 8-9, the third configuration of the attachment portion 50 is removably attached to the transportation element 100 with the tie down ring 59, a tie down 57, a platform 72, and anchors 101, with the camper pod 1 positioned in a truck bed. The platform 72 is used to raise the camper pod 1 over wheel wells of the transportation element 100. The platform 72 may have internal storage space. First, as shown in FIG. 8, the platform 72 is placed on the transportation element 100. The camper pod 1 is then placed on the platform 72. Each tie down 57, as shown in FIG. 9, is then attached between each tie down ring 59 and each anchor 101. The camper pod 1 is then removably secured to the transportation element 100 when each tie down 57 is tightened.

As shown in FIG. 7, the third configuration of the attachment portion 50 is removably attached to the transportation element 100 with the tie down ring 59, the tie down 57, and optionally a spacer 70 or a plurality of spacers 70. The spacer(s) 70 are used to fill a space between the camper pod 1 and a portion of the transportation element 100, as shown in FIG. 7. The camper pod 1 of the embodiment shown in FIG. 7 fits between wheel wells of the transportation element 100. First, as shown in FIG. 7, the camper pod 1 is placed on the transportation element 100 between the wheel wells. The spacers 70 are then placed against the pair of sidewalls 25 and the portion of the transportation element 100. Each tie down 57 is then attached to each tie down ring 59 and each anchor 101 as described with respect to FIGS. 8 and 9. The camper pod 1 is then removably secured to the transportation element 100 when each tie down 57 is tightened.

The camper pod 1 removably attached to the transportation element 100 according to FIGS. 7-9 has each anchor 101 attached on a rail or in walls of a bed or a bottom of the bed of the transportation element 100. However, each anchor 101 may be attached on any portion of the transportation element 100 that allows the camper pod 1 to be removably attached to the transportation element 100 with the third configuration of the attachment portion 50.

The embodiments of the camper pod 1 have a lightweight construction; in various embodiments, the camper pod 1 weighs no more than 200 lbs, not including the weight of any of the plurality of accessory elements 60 that may be attached to the camper pod 1. The camper pod 1, unlike other typical campers, is sufficiently lightweight to be manually loaded onto the transportation element 100 with only a few people, such as two people, or even a single person. Additionally, the camper pod 1 is sufficiently durable to withstand being transported on the transportation element 100 and used in the elements. The structure layers 11 cure to a hardness that provides durability, longevity, and chemical/water resistance to the camper pod 1. For example, the pure aromatic polyurea provides optimal durability, while a hybrid polyurea provides sufficient durability while being more cost effective.

The camper pod 1, according to an exemplary embodiment, is sized to fit a single person or a pair of people. The camper pod 1 is also sufficiently insulated, by the material of the housing body 12 and the structure layers 11, such that the body heat of the individual(s) inside can provide sufficient heat for multiple seasons. For example, body heat alone can keep an inside temperature of the camper pod 1 between 50-55 degrees Fahrenheit when a temperature of an environment surrounding the camper pod 1 is 20 degrees Fahrenheit. The port 42 also permits the use of an additional heater or other electrical elements if necessary.

What is claimed is:

1. A camper pod, comprising:
a camper housing having a housing body and a pair of structure layers positioned on opposite surfaces of the housing body, the housing body is formed of a foam material and the pair of structure layers are each formed of a resin material deposited on the foam material; and
an attachment portion removably attaching the camper housing to a transportation element.

2. The camper pod of claim 1, wherein the resin material is a pure polyurea material, a hybrid polyurea material, or an aliphatic polyurea material.

3. The camper pod of claim 1, wherein the foam is a closed cell-foam having a density of at least 2.4 lbs/ft³.

4. The camper pod of claim 1, wherein the housing body has a thickness of at least 2″.

5. The camper pod of claim 4, where each of the structure layers has a thickness greater than or equal to 2/32″ and less than or equal to 5/32″.

6. The camper pod of claim 1, wherein a UV protection layer is applied on at least one of the structure layers.

7. The camper pod of claim 1, wherein a UV protection layer is integrated into at least one of the structure layers.

8. The camper pod of claim 1, wherein the camper housing has a first roof and a second roof adjacent to the first roof, the second roof has an angle greater than 0° and less than 90° with respect to a plane of the first roof.

9. The camper pod of claim 8, wherein the camper housing has an embedded strip extending across the first roof and receiving a ratchet strap of the attachment portion.

10. The camper pod of claim 1, wherein the attachment portion has a plate disposed on a bottom of the camper housing, the plate removably attaches the bottom of the camper housing to a substrate of the transportation element.

11. The camper pod of claim 10, wherein the attachment portion includes a plurality of fasteners extending through the plate, the bottom of the camper housing, and the substrate of the transportation element.

12. The camper pod of claim 1, wherein the attachment portion has a plate attached to a sidewall of the camper housing, a tie down ring attached to the plate, and a tie down attached between the tie down ring and an anchor of the transportation element.

13. The camper pod of claim 1, further comprising a door and an outlet attached to a rear wall of the housing body, a pair of windows each attached to one sidewall of the housing body, and a vent attached to the one sidewall of the housing body.

14. The camper pod of claim 1, further comprising at least one of: a storage rack attached on a roof of the housing body, a solar panel attached on a roof of the housing body, and a fan attached to a rear wall of the housing body.

15. The camper pod of claim 1, wherein the camper pod has a weight of less than or equal to 200 lbs.

16. A camper, comprising:
a transportation element; and
a camper pod including a camper housing having a housing body and a pair of structure layers positioned on opposite surfaces of the housing body, the housing body is formed of a foam material and the pair of structure layers are each formed of a resin material deposited on the foam material, the camper pod has an attachment portion removably attaching the camper housing to the transportation element.

17. The camper of claim 16, wherein the transportation element is a truck bed or a trailer.

18. A method of removably attaching a camper pod to a transportation element, comprising:
providing the camper pod having a weight less than or equal to 200 lbs;
manually lifting the camper pod;
placing the camper pod on the transportation element; and
removably attaching the camper pod to the transportation element with an attachment portion of the camper pod.

19. The method of claim 18, further comprising a plurality of steps of assembling the camper pod, including:
cutting a plurality of foam panels of a housing body;
attaching the plurality of foam panels of the housing body together; and
spraying a resin material on an interior of the housing body and an exterior of the housing body.

20. The method of claim 19, wherein the spraying step includes separately heating the resin material and an isocyanate, combining the heated resin material and the heated isocyanate, and spraying the resin material combined with the isocyanate on the interior of the housing body and the exterior of the housing body.
